(19) United States
(12) Patent Application Publication
(10) Pub. No.: US 2018/0067467 A1
(43) Pub. Date: Mar. 8, 2018

(54) MACHINING SYSTEM AND ROBOT SYSTEM

(71) Applicant: Fanuc Corporation, Yamanashi (JP)

(72) Inventors: Kiyotaka OKUZONO, Yamanashi (JP); Ryuji TAKIKAWA, Yamanashi (JP)

(73) Assignee: Fanuc Corporation, Yamanashi (JP)

(21) Appl. No.: 15/657,912

(22) Filed: Jul. 24, 2017

(30) Foreign Application Priority Data
Sep. 8, 2016 (JP) 2016175325

(51) Int. Cl. G05B 19/402; B25J 11/00

(52) U.S. Cl. CPC G05B 19/402; G05B 2219/40243; B25J 11/0055

(57) ABSTRACT

There is provided a machining system including: a machine tool that moves a table on which a plurality of works are fixed, in a two-dimensional manner, to machine the one work by driving a blade shaft in a direction orthogonal to a moving direction of the table; a robot that is disposed at a position accessible to the table of the machine tool to apply processing to the other one work fixed to the table; and a robot control unit that controls the robot so as to follow movement of the table on the basis of position information on the table.

### CROSS-REFERENCE TO RELATED APPLICATIONS

This application claims the benefit of Japanese Patent Application No. 2016-175325, the content of which is incorporated herein by reference.

### TECHNICAL FIELD

The present invention relates to a machining system and a robot system.

### BACKGROUND ART

Conventionally, there is known a machining system including a machine tool that performs machining by fixing a plurality of works on a machining table at rest, and moving a blade shaft to the works, the machining system allowing a machined work to be washed while performing machining with a blade, and a machined work to be changed for an unmachined work using picking up by a robot (e.g., refer to PTL 1).

### CITATION LIST

### Patent Literature

{PTL 1} Japanese Unexamined Patent Application, Publication No. 2009-297861

### SUMMARY OF INVENTION

An aspect of the present invention provides a machining system including: a machine tool that moves a table on which a plurality of works are fixed, in a two-dimensional manner, to machine one of the works by driving a blade shaft in a direction orthogonal to a moving direction of the table; a robot that is disposed at a position accessible to the table of the machine tool to apply processing to the other one of the works fixed to the table; and a robot control unit that controls the robot so as to follow movement of the table on the basis of position information on the table.

In addition, another aspect of the present invention provides a robot system including: a robot that is disposed at a position accessible to a table of a machine tool that moves the table on which a plurality of works are fixed, in a two-dimensional manner, to machine one of the works by driving a blade shaft in a direction orthogonal to a moving direction of the table, the robot applying processing to the other one of the works fixed to the table; a position information detector that detects position information on the table; and a robot control unit that controls the robot so as to follow movement of the table on the basis of the position information detected by the position information detector.

### BRIEF DESCRIPTION OF DRAWINGS

FIG. 1 is a plan view illustrating general structure of a machining system according to an embodiment of the present invention.

FIG. 2 is a front view illustrating the machining system of FIG. 1.

FIG. 3 is a flowchart illustrating movement of a robot in the machining system of FIG. 1.

FIG. 4 is a flowchart illustrating a routine of delivery of a machined work in the flowchart of FIG. 3.

FIG. 5 is a flowchart illustrating a routine of mounting of an unmachined work in the flowchart of FIG. 3.

FIG. 6A illustrates a state of a robot following movement of a table in the machining system of FIG. 1, where a hand is disposed above a work.

FIG. 6B illustrates a state, from the state illustrated in FIG. 6A, where the hand descends.

FIG. 6C illustrates a state, from the state illustrated in FIG. 6B, where the work is held.

FIG. 6D illustrates a state, from the state illustrated in FIG. 6C, where the work is picked up.

FIG. 7 illustrates a time chart of machining of a work by a conventional machining system, as a reference example.

FIG. 8 is a time chart illustrating machining of a work by the machining system of FIG. 1.

FIG. 9 is a plan view illustrating a first modification of the machining system of FIG. 1.

FIG. 10 is a plan view illustrating a second modification of the machining system of FIG. 1.

FIG. 11 is a plan view illustrating a third modification of the machining system of FIG. 1.

### DESCRIPTION OF EMBODIMENTS

A machining system 1 according to an embodiment of the present invention will be described below with reference to drawings.

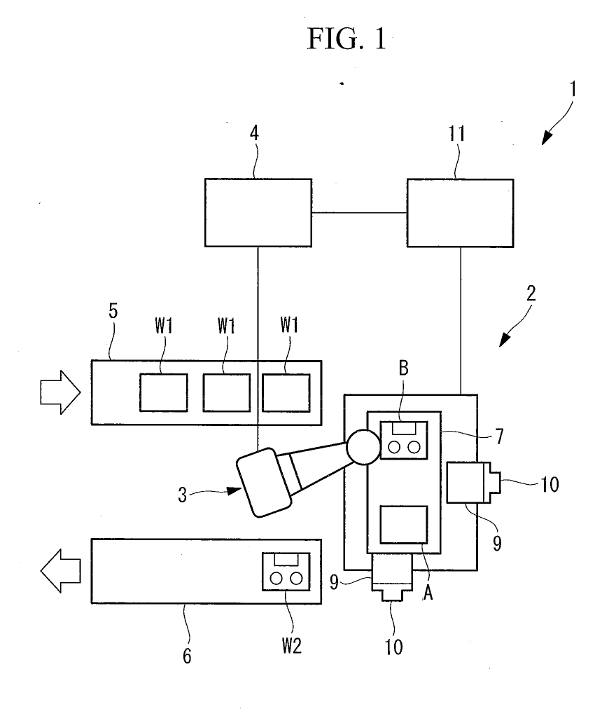

As illustrated in FIG. 1, a machining system 1 according to the present embodiment includes a machine tool 2, a robot 3, a robot controller (robot control unit) 4 that controls the robot 3, a supply conveyor 5 that supplies a work W1 that is unmachined, and a delivery conveyor 6 that delivers a work W2 that is machined.

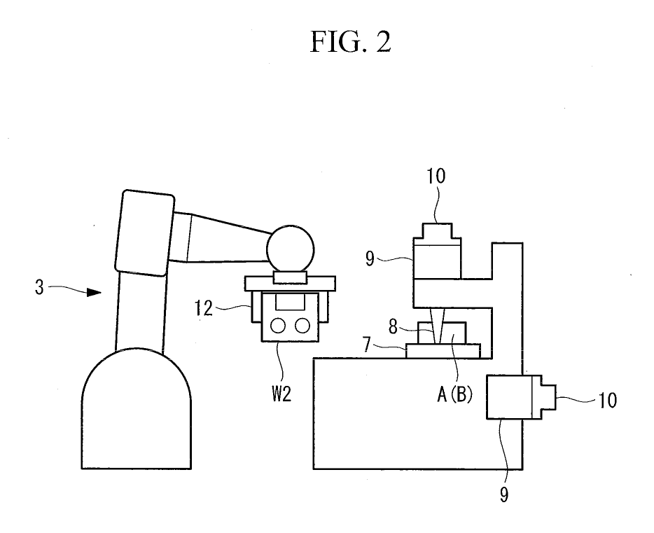

As illustrated in FIGS. 1 and 2, the machine tool 2 includes a table 7 that has a top face on which a work W1 is fixed, and that is moved in two horizontal axial directions, a blade shaft 8 that vertically moves a tool, such as a drill, along a vertical axis, and that rotates the drill around the vertical axis, motors 9 that drive the table 7 and the blade shaft 8, encoders 10 that detect a rotation angle of each of the motors 9, and a machine controller (machine control unit) 11 that controls the motor 9 on the basis of a rotation angle detected by the encoder 10. The machine controller 11 is connected to the robot controller 4 to transmit information on a rotation angle of the motor 9 detected by the encoder 10 for position control of the table 7 to the robot controller 4.

As illustrated in FIG. 1, two works A and B can be fixed on the table 7. Each of the works A and B is fixed on the table 7 by using any fixing means (not illustrated) including a clamp driven by a hydraulic cylinder, an air pressure cylinder, or an actuator such as a motor and a magnet. In the present embodiment, two works fixed on the table 7 are indicated as works A and B, regardless of being unmachined or machined.

For example, the robot 3 is a six-axis articulated type robot, and includes a hand 12 that are provided on an attaching face of a wrist of the robot 3 to hold a work W1 or W2. For the robot 3, any type of robot having a transportable weight and a movement range that enable handling of works W1 and W2 are available.

The robot controller 4 acquires position information on the table 7 of the machine tool 2 on the basis of information on a rotation angle received from the machine controller 11 of the machine tool 2. The robot controller 4 causes operation as follows to be repeated: each axis of the robot 3 is driven so that a machined work W2 on the table 7 is held by the hand 12 provided in the wrist of the robot 3; the machined work W2 being held is picked up from the table 7, and is moved to the delivery conveyor 6 for a machined work W2 to be released; then the hand 12 is moved to the supply conveyor 5 to hold an unmachined work W1 being supplied; and the unmachined work W1 being held is moved to a predetermined position on the table 7 to be released.

In this case, when the robot 3 picks up a machined work W2 from the table 7, the robot controller 4 controls (tracking) the robot 3 so as to perform movement acquired by combining movement to pick up a machined work W2 on the table 7 at rest, with movement of the table 7. In addition, when the robot 3 supplies an unmachined work W1 to the table 7, the robot controller 4 controls (tracking) the robot 3 so as to perform movement acquired by combining movement to supply a work W1 to the table 7 at rest, with movement of the table 7.

Operation of the machining system 1 configured as describe above, according to the present embodiment, will be described below.

When a work W1 is machined by using the machining system 1 according to the present embodiment, two works A and B are fixed on the table 7 of the machine tool 2. Then, a correspondence between a coordinate system of the machine tool 2 and a coordinate system of the robot 3 is acquired. Any publicly known method is available for a method of acquiring a correspondence between the coordinate systems.

When the machine tool 2 starts machining of the one work A, the machine controller 11 causes the motor 9 of the table 7 and the motor 9 of the blade shaft 8 to be driven according to a program. At this time, a rotation angle of each of the motors 9 is detected by the encoder 10 provided in the motor 9, and feedback control is applied to the motor 9 on the basis of the detected rotation angle.

Information on the detected rotation angle of the motor 9 of the table 7 is sequentially transmitted to the robot controller 4 connected to the machine controller 11. When machining of the works A and B fixed on the table 7 is finished, the machine controller 11 transmits a signal indicating finish of machining to the robot controller 4.

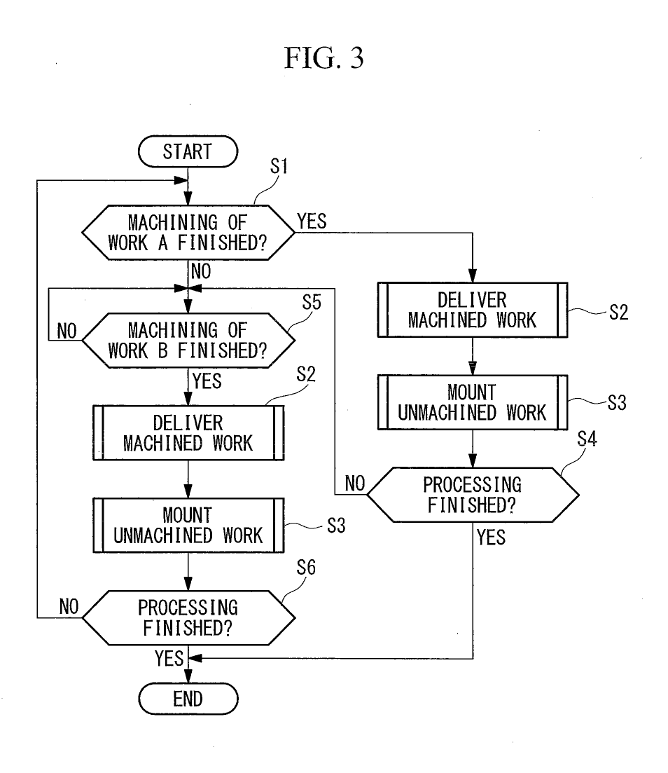

As illustrated in FIG. 3, the robot controller 4 determines whether a signal indicating finish of machining of work A is received (step S1). When the signal is received, a machined work delivery routine S2, and an unmachined work mounting routine S3, are performed.

In the machined work delivery routine S2, the robot 3 is moved so as to pick up the machined work A from the table 7. At this time, the machine tool 2 performs machining of the other work B. That is, the table 7 is moved in a horizontal direction to machine the work B, and the machined work A is also moved simultaneously with the work B.

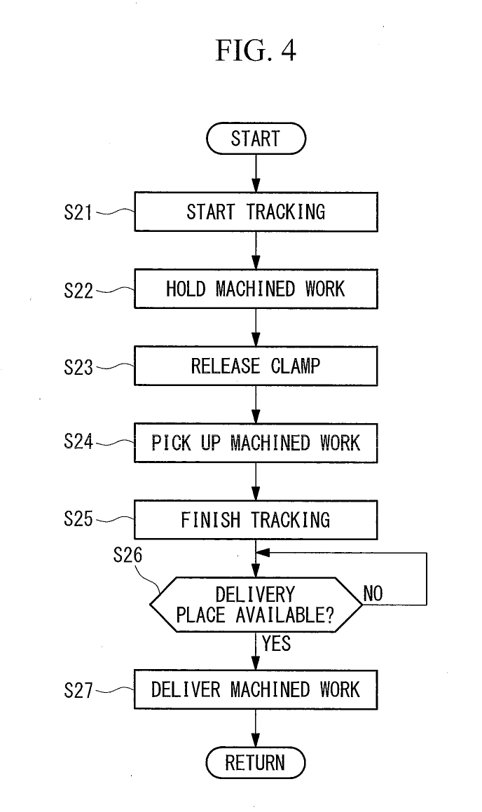

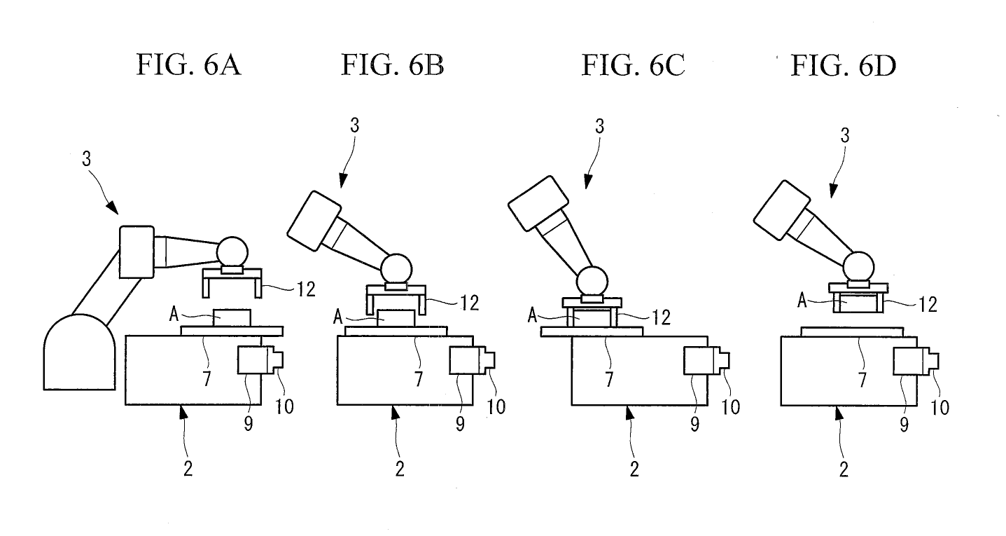

In an operation of picking up a machined work A from the table 7 by using the robot 3, first the robot controller 4 causes the robot 3 to start tracking (step S21), as illustrated in FIG. 4. When the tracking is started, the robot controller 4 controls the robot 3 so as to perform movement acquired by combining movement of the robot 3 to pick up a work A on the table 7 at rest, with movement of the table 7, as illustrated in FIGS. 6A to 6D.

Specifically, the hand 12 is moved by following movement of the work A by movement of the table 7 to hold the work A (step S22), and a clamp fixing the work A on the table 7 is simultaneously released (step S23). Then, the hand 12 is raised to pick up the work A from the table 7 (step S24). At this time, the tracking is finished (step S25).

It is determined whether a delivery place of the delivery conveyor 6 is available (step S26). When the delivery place is not available, the hand 12 is kept on standby until the delivery place becomes available. When the delivery place becomes available, the hand 12 is moved to transfer the work A held to the delivery conveyor 6, and then the hand 12 is opened above the delivery place to release the work A (step S27).

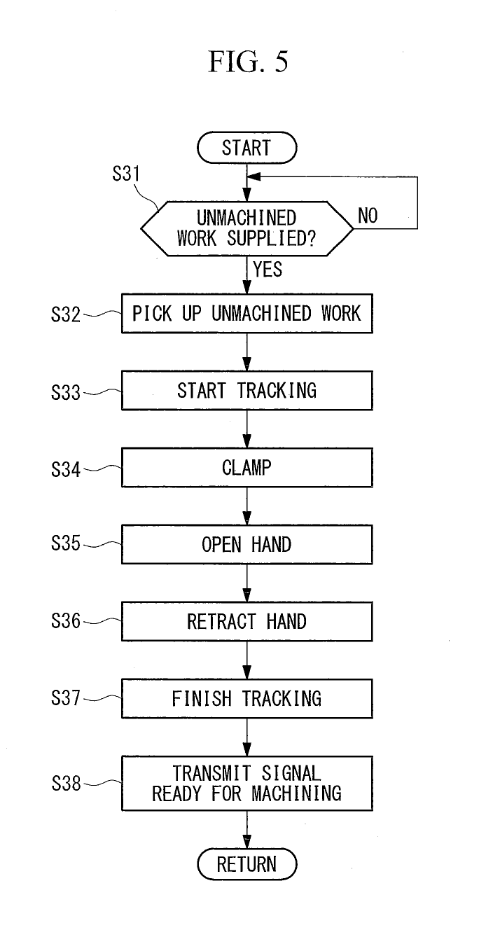

Subsequently, in the unmachined work mounting routine S3, as illustrated in FIG. 5, the robot 3 checks whether an unmachined work W1 is supplied to a supply place of the supply conveyor 5 that supplies an unmachined work W1 (step S31). When no unmachined work W1 is supplied, the robot 3 is kept on standby until an unmachined work W1 is supplied. When an unmachined work W1 is supplied, the hand 12 is moved to the supply place to hold and pick up the unmachined work W1 (step S32).

Then, the robot controller 4 causes the robot 3 to start tracking (step S33). Accordingly, the hand 12 is moved by following movement of the table 7 on which a work B is machined. While the robot 3 is moved so as to maintain the unmachined work W1 at a position corresponding to a fixing place on the table 7, fixing of the work W1 by using the clamp (step S34), as well as releasing of the work W1 from the hand 12 (step S35) is performed. When the hand 12 is retracted to a position at which the hand 12 have no contact with the work W1 (step 36), the tracking is finished (step S37). Then, a signal indicating that the unmachined work W1 mounted on the table 7 is ready for machining is transmitted to the machine tool 2 (step S38).

At the time, it is checked whether a finish command of machining is received (step S4). When no finish command is received, it is determined whether a signal indicating finish of machining of the work B is received (step S5). When the signal is received, the machined work delivery routine S2 and the unmachined work mounting routine S3 are performed. Then, it is checked whether a finish command of machining is received (step S6). When no finish command is received, steps from step S1 are repeated.

As described above, in the machine tool 2 that machines works A and B fixed on the table 7 in a three-dimensional manner by combining machining with the blade shaft 8 in a vertical direction with feeding by the table 7 in a horizontal direction, the machining system 1 according to the present embodiment enables the robot 3 to pick up the other work B being machined and mount an unmachined work W1, during machining of the one work A. That is, there is an advantage in machining efficiency that can be greatly improved by reducing waiting time of the robot 3 and the machine tool 2 for the machine tool 2 capable of achieving a high machining feed rate and high machining accuracy by eliminating horizontal movement of the blade shaft 8 in large weight.

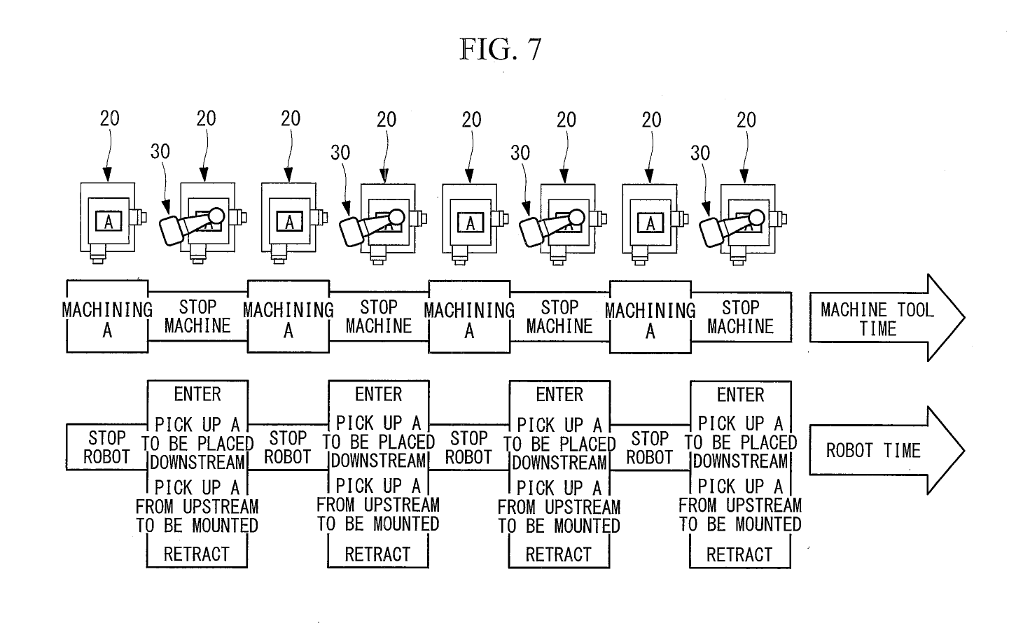

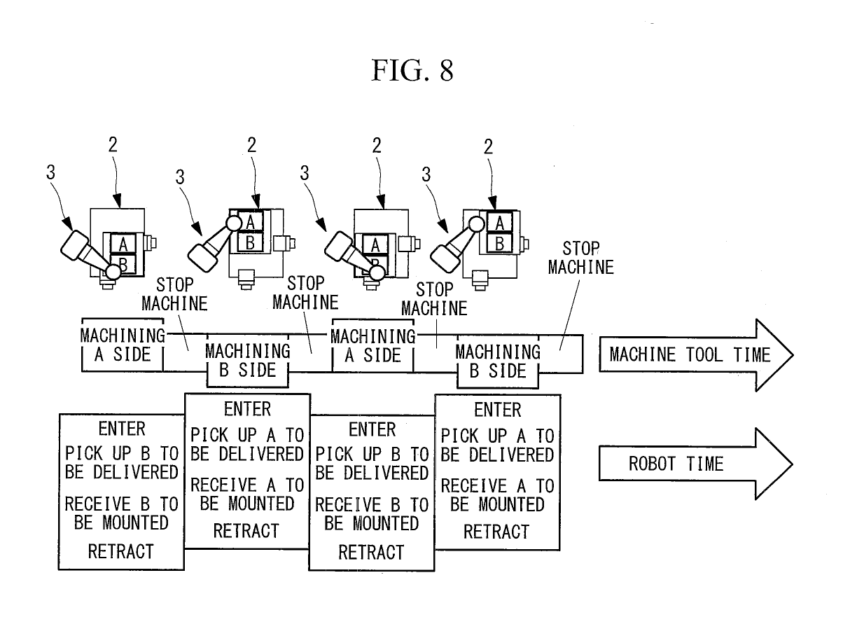

More specifically, conventionally during machining of a work A, a robot 30 replaces the work A only when the robot 30 is stopped and machining of the work A is finished to stop the machine tool 20, as illustrated in FIG. 7. In contrast, the present embodiment enables removal and delivery of a machined work B, and picking up and mounting of an unmachined work B, during machining of a work A, as illustrated in FIG. 8, so that stop time of the robot 3 can be eliminated. The robot 3 may stop for only a short time because stop time of the machine tool 2 is eliminated depending on machining time.

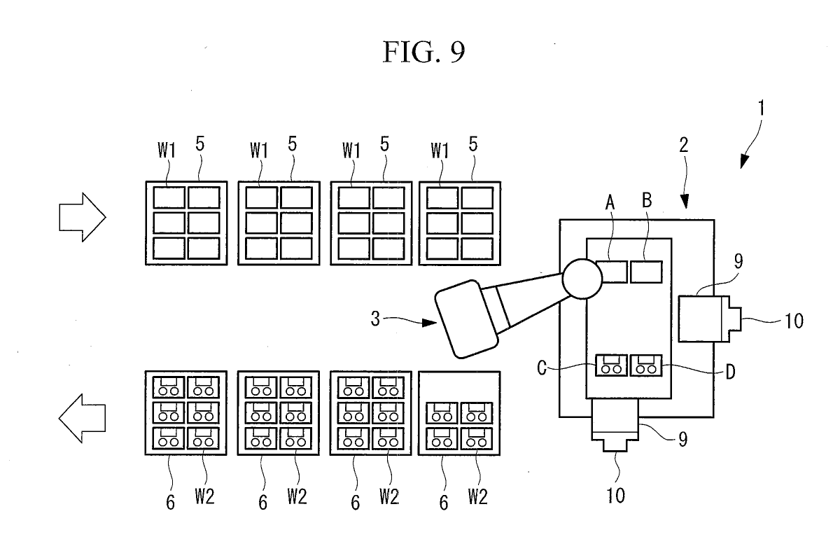

In the present embodiment, two works A and B are disposed on the table 7, and during machining of the one work A, the robot 3 processes the other work B. Besides this, three or more works (four works in FIG. 9), such as works A, B, C, and D, may be disposed on the table 7 as illustrated in FIG. 9 to allow the robot 3 to process one or more of the works B, C, and D during machining of the one work A.

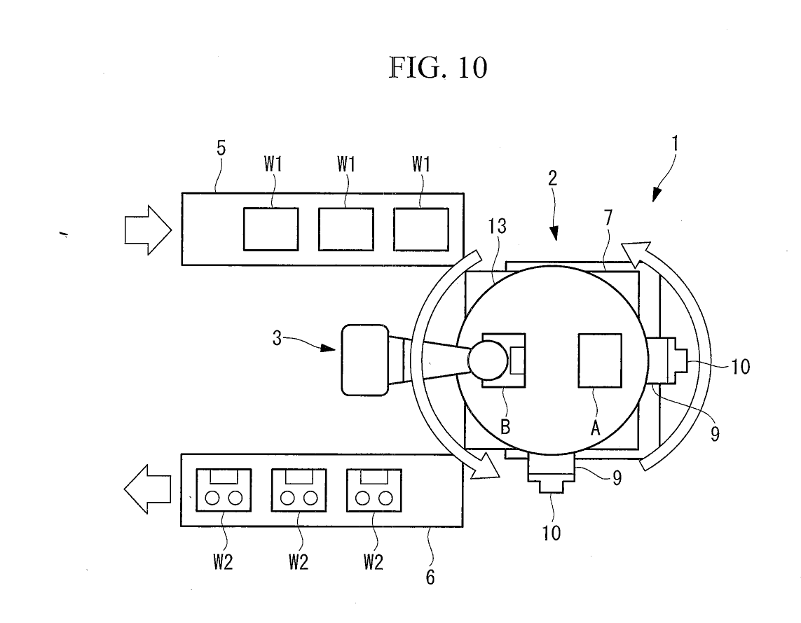

As illustrated in FIG. 10, there is available a machine tool 2 capable of moving a machined work W2 to a position facilitating picking up of the machined work W2 by proving a turn table 13 rotatable around a vertical axis on the table 7. The robot 3 processes the works W1 and W2 also in synchronization with rotation of the turn table 13, so that productivity can be further improved.

In the present embodiment, while there is described a case where the robot 3 performs a process of changing a machined work W2 for an unmachined work W1, a process performed by the robot 3 is not limited to change of the works W1 and W2, and thus the robot 3 may perform another any process, such as washing of the works W1 and W2.

While a rotation angle detected by the encoder 10 of the motor 9 that drives the table 7 is transmitted to the robot 3 as position information on the table 7 when the machine tool 2 machines a work W1 in the present embodiment, a linear scale (not illustrated) instead of the encoder 10 may be attached to the table 7. That is, position information on the table 7 is directly acquired by using the linear scale, and the robot 3 may be controlled on the basis of the position information acquired.

Instead of the linear scale, position information on the table 7 may be acquired by using a ranging sensor, such as a laser ranging device. In addition, position information on the table 7 may be acquired by an encoder (not illustrated) that is attached to a table driving part (not illustrated), such as a ball screw, in addition to the encoder 10 configured to control the motor 9 that drives the table 7. Further, information on a rotation angle detected by the encoder 10, and position information detected by a linear scale or another device that detects a position of the table 7, may be combined with each other to be used.

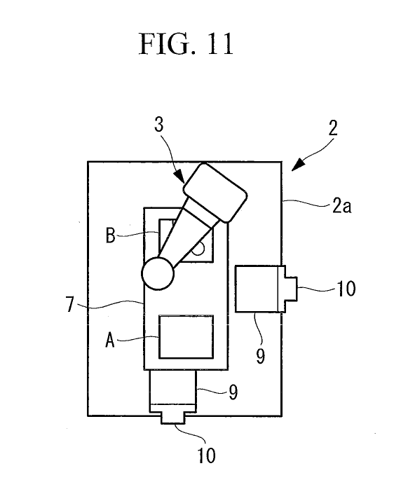

While there is described an example in which the robot 3 is disposed outside the machine tool 2 in the present embodiment, besides this, the robot 3 may be provided on a base 2a inside the machine tool 2 as illustrated in FIG. 11.

While there is described the machining system 1 including the robot 3 and the machine tool 2 in the present invention, besides this, there is available a robot system including a robot 3, a sensor (position information detector) attached to a table 7 of a machine tool 2 to detect position information on the table 7, and a robot controller 4 that controls the robot 3 on the basis of position information detected by the sensor. A control method of the robot 3 by using the robot controller 4 is similar to that described above. According to the present embodiment, when a sensor is provided in a table 7 of an existing machine tool 2 to detect position information on the table 7, it is possible to achieve effect as with the machining system 1 described above.

From the above-described embodiment, the following invention is derived.

An aspect of the present invention provides a machining system including: a machine tool that moves a table on which a plurality of works are fixed, in a two-dimensional manner, to machine one of the works by driving a blade shaft in a direction orthogonal to a moving direction of the table; a robot that is disposed at a position accessible to the table of the machine tool to apply processing to the other one of the works fixed to the table; and a robot control unit that controls the robot so as to follow movement of the table on the basis of position information on the table.

According to the present aspect, while a plurality of works are fixed to the table of the machine tool and is moved in a two-dimensional manner so that one of the works on the table is machined by driving the blade shaft in a direction orthogonal to a moving direction of the table, the robot control unit controls the robot disposed at a position accessible to the table so as to follow the movement of the table, thereby applying processing to the other one of works on the table. This enables another work to be processed during machining of one of the works without waiting for finishing machining of the one of the works by the machine tool while improving machining accuracy and a machining feed rate by using a machining method of moving a work, so that a stand-by time of each of the robot and the machine tool to process a work can be reduced to improve machining efficiency.

In the aspect above, the robot control unit may control the robot so as to perform movement acquired by combining movement of the robot to apply processing to the other one of works while the table is at rest, with movement of the table.

This allows the robot to follow movement of the table while the table on which the works are fixed is moved during machining of one of the works on the table, so that the robot can be moved to perform processing as if to process the other one of the works, being unmachined, on the table at rest.

In the aspect above, the robot may include a hand capable of holding the work, and processing of the robot for the other one of works may be picking up of the work from the table and attaching of the work to the table by using the hand.

This enables the hand provided in the robot to remove the other one of the works on the moving table from the table or attach the other one of the works on the moving table during machining of one of the works on the table while the table on which the works are fixed is moved. That is, even in a machine tool using a method of moving a table during machining, it is possible to pick a machined work and attach an unmachined work to the table during machining of one of works.

In the aspect above, the machine tool may include a motor that drives the table, an encoder that acquires the position information on the table by detecting a rotation angle of the motor, and a machine control unit that controls the motor on the basis of a rotation angle detected by the encoder, and the machine control unit may transmit the position information on the table acquired by the encoder to the robot control unit.

This enables the robot control unit to acquire position information on the table of the machine tool to control the robot so as to follow movement of the table by transmitting a rotation angle of the motor detected by the encoder to control the motor, which drives the table when a work is machined, to the robot control unit in the machine tool.

In the aspect above, the position information may be acquired by using a linear scale provided in the table.

In addition, the position information may be acquired by using a ranging sensor, such as a laser ranging device, instead of the linear scale.

In the aspect above, the position information may be acquired by an encoder that is attached to a table driving part, such as a ball screw, in addition to the encoder configured to control the motor that drives the table.

This enables position information on the table to be directly detected by using a linear scale or another device for detecting a position of the table, and the position information can be used for control of the robot by the robot control unit.

In addition, another aspect of the present invention provides a robot system including: a robot that is disposed at a position accessible to a table of a machine tool that moves the table on which a plurality of works are fixed, in a two-dimensional manner, to machine one of the works by driving a blade shaft in a direction orthogonal to a moving direction of the table, the robot applying processing to the other one of the works fixed to the table; a position information detector that detects position information on the table; and a robot control unit that controls the robot so as to follow movement of the table on the basis of the position information detected by the position information detector.

### REFERENCE SIGNS LIST

1 machining system
2 machine tool
3 robot
4 robot controller (robot control unit)
7 table
8 blade shaft
9 motor
10 encoder
11 machine controller (machine control unit)
12 hand
13 turn table
A, B, C, D, W1, W2 work

1. A machining system comprising:
a machine tool that moves a table on which a plurality of works are fixed, in a two-dimensional manner, to machine one of the works by driving a blade shaft in a direction orthogonal to a moving direction of the table;
a robot that is disposed at a position accessible to the table of the machine tool to apply processing to the other one of the works fixed to the table; and
a robot control unit that controls the robot so as to follow movement of the table on the basis of position information on the table.

2. The machining system according to claim 1, wherein
the robot control unit controls the robot so as to perform movement acquired by combining movement of the robot to apply processing to the other one of works while the table is at rest, with movement of the table.

3. The machining system according to claim 1, wherein
the robot includes a hand capable of holding the work, and
processing of the robot for the other one of works is picking up of the work from the table and attaching of the work to the table by using the hand.

4. The machining system according to claim 1, wherein
the machine tool includes a motor that drives the table, an encoder that acquires the position information on the table by detecting a rotation angle of the motor, and a machine control unit that controls the motor on the basis of a rotation angle detected by the encoder, and
the machine control unit transmits the position information on the table acquired by the encoder to the robot control unit.

5. The machining system according to claim 1, wherein
the position information is acquired by using a linear scale provided in the table.

6. A robot system comprising:
a robot that is disposed at a position accessible to a table of a machine tool that moves the table on which a plurality of works are fixed, in a two-dimensional manner, to machine one of the works by driving a blade shaft in a direction orthogonal to a moving direction of the table, the robot applying processing to the other one of the works fixed to the table;
a position information detector that detects position information on the table; and
a robot control unit that controls the robot so as to follow movement of the table on the basis of the position information detected by the position information detector.
